(19) United States
(12) Patent Application Publication
(10) Pub. No.: US 2009/0302778 A1
(43) Pub. Date: Dec. 10, 2009

(54) SWITCHING LED DRIVER CIRCUIT

(76) Inventor: Pei-Choa Wang, Gueishan Township (TW)

Correspondence Address: HDLS Patent & Trademark Services, P.O. BOX 220746, CHANTILLY, VA, 20153-0746, US

(21) Appl. No.: 12/136,286

(22) Filed: Jun. 10, 2008

(51) Int. Cl. H05B 41/36

(52) U.S. Cl. 315/294

(57) ABSTRACT

An LED driver circuit sequentially and repeatingly switches a plurality of LED arrays to result in blink with high frequency. A PWM generator outputs n series of high frequency periodic PWM signals. The period (T) and duty cycle (d) of each series of PWM signal are the same as each other, but pulse portions of the PWM signals sequentially follow over time, i.e. d=1/n. Each PWM signal is sent to a dimming constant current source for separately outputting a driving power with the same timing as the input PWM signals to one of the LED arrays, so that the LED arrays make a high frequency blink. The blink frequencies of each and overall LED arrays are 1/T Hz and n/T Hz, respectively. The driving current of LEDs can be increased over a rated average forward current I_{AVG} because they are not lit up continuously. By persistence of vision of the eye, a visual effect with continuity and high brightness can be obtained.

### TECHNICAL FIELD

The present invention relates to light emitting diodes (LEDs), particularly to a circuit for driving a plurality of LEDs.

### BACKGROUND OF THE INVENTION

In recent years, the manufacturing and applying technologies of light emitting diodes (LEDs) have developed rapidly and highly. Because of the advantage of great durability and energy-saving, the LEDs have increasingly replaced conventional light sources such as fluorescent lamps, incandescent lamps, halogen bulbs, traffic lights and even backlight of LCD panels. More recently, most LED lamps tend to use one or more LED arrays composed of a plurality of LEDs for heightening overall brightness.

An LED is a semiconductor device with a PN junction, which can emit light when a forward current flows through. The LEDs have an important property, which is the direct proportion relationship between the luminous intensity and forward current. In other words, the larger the forward current is, the higher the luminous intensity is. However, a larger forward current is also accompanied with higher heat. It is very possible that excessive heat results in permanent damage or durability shortening for LEDs. Therefore, LED manufactures always rate an average forward current I_{AVG} for each model of LED under continuous operation and a peak pulsed forward current I_{PK} under momentary operation. The latter must be higher than the former. When an LED performs a high frequency blink, a forward current higher than I_{AVG} and up to I_{PK} can be applied to obtain an instantaneous luminous intensity. When an LED lights up continuously, only a forward current not greater than I_{AVG} can be applied. The luminous intensity generated by continuous forward current is continuous and consistent but must be lower than the instantaneous luminous intensity.

Conventional LED lamps always works under a mode of continuously lighting up, which only can allow a forward current not greater than I_{AVE} being applied. If higher luminous intensity than what I_{AVE} can generate is required, the only solution is to replace original LEDs with higher power ones. However, no doubt, this solution will require considerable expense of purchase. Furthermore, the problem of heat dissipation accompanying higher power LEDs is also harder to solve. On the other side, development of LED or any other productions must be gradually progressive. Each period always has a specific limitation of technique. There is no product which can satisfy all applied requirement in the markets. For example, so far a single LED whose power is higher than 10 W is rare to appear in the markets. Therefore, a technique, which can heighten luminous intensity of existing LED products without resulting in heat increasing and durability shortening, is necessarily required.

### SUMMARY OF THE INVENTION

The human eye has a property of persistence of vision, which can generate a brain-made illusion of mistaking an illuminator with high frequency blink for continuously lighting up. For example, if an ordinary fluorescent lamp (tube) is driven by a transformer-typed ballast, a blink with a frequency of double the frequency of alternating current (AC) city electricity will appear. (because there are two zero-cross points in a sinusoidal period.) That is to say, a 60 Hz city electricity will cause a 120 Hz blink. The blink with such a low frequency still can be sensed by the human eye, and even may result in a disadvantageous influence on the human eye. There thus are higher level lamps adopting electronic ballasts in the markets. This kind of ballast converts frequency of city electricity into a high frequency range of 10-30 kHz for making the blink frequency heightened to 20-60 kHz. Such a high frequency blink has been out of sensing by the human eye, and can cause a mistaken visual effect of continuous illumination. In other words, though the LEDs themselves are to blink, they are to continuously light up for the human eye.

The present invention utilizes this property to apply a discontinuous current with high frequency switching to a plurality of LEDs or LED arrays for making them sequentially blink. The applied current can be higher than the rated average forward current I_{AVE} and up to the rated peak pulsed forward current I_{PK}. Therefore, the luminous intensity of LEDs can be heightened with no heat increasing, saving costs of purchasing higher power LEDs and accompanying problem of heat dissipation.

### BRIEF DESCRIPTION OF THE DRAWINGS

FIG. 1 is a block diagram of a preferred embodiment according to the present invention; and

FIG. 2 shows timing of PWM signals output by the PWM generator in the embodiment of FIG. 1.

### DETAILED DESCRIPTION OF THE PREFERRED EMBODIMENT

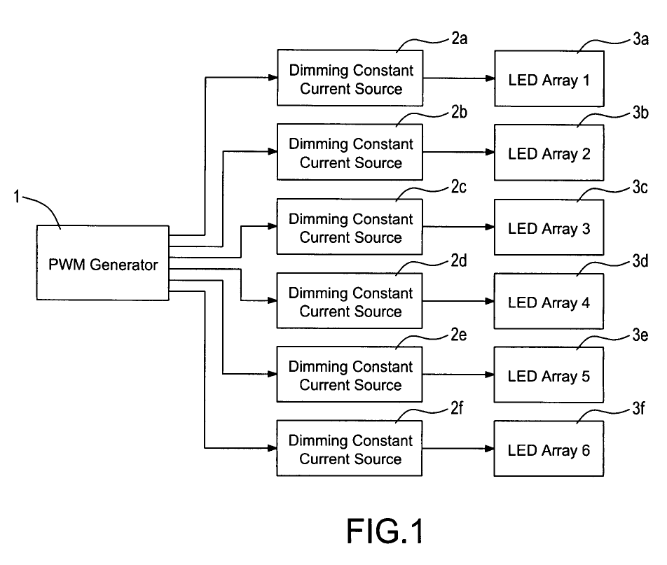

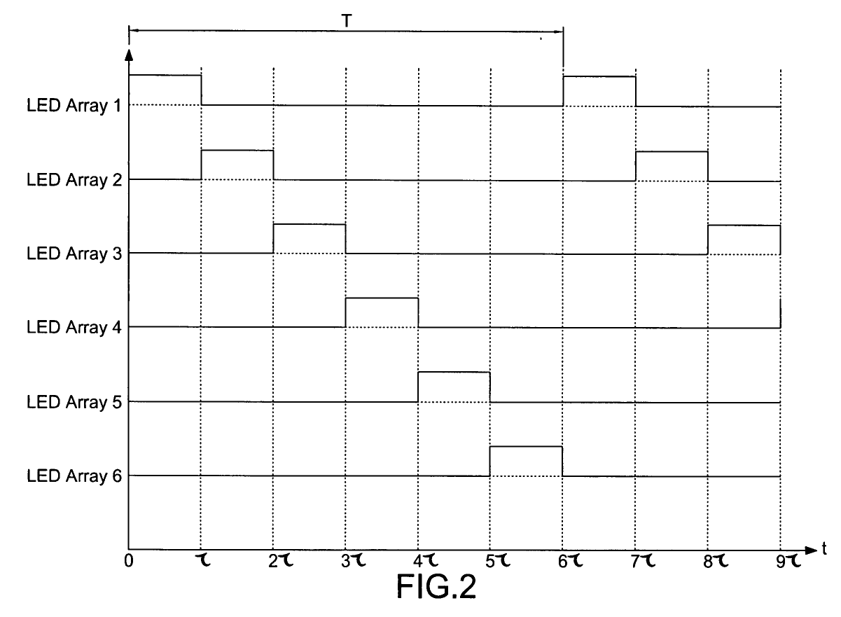

FIG. 1 is a block diagram of a preferred embodiment of an LED driver circuit according to the present invention. The driver circuit includes a pulse width modulation (PWM) generator 1, a plurality of dimming constant current source 2a˜2f and a plurality of LED arrays 3a˜3f, in which the number of the dimming constant current source 2a˜2f is the same as that of the LED arrays 3a˜3f and both of them are under a one-to-one arrangement. FIG. 1 shows an example of six sets, but any other quantities except 1 are available. On the other side, the abovementioned description points out an embodiment which combines separate six LED arrays into a whole larger array. For example, if each LED array 3a˜3f is composed of 10 LEDs, six LED arrays 3a˜3f will constitute a larger array having 60 LEDs. Of course, every single LED array 3a˜3f can also be a single LED, i.e. combining 6 LEDs into an LED array. Additionally, the abovementioned dimming constant current source 2a˜2f is a direct current (DC) constant current source having a PWM signal input terminal, whose constant current output can be controlled by the input PWM signal to cause synchronous intermittence. A preferred example of commercial products is a DC/DC converter integrated circuit with model number MB16650 made by Macroblock, Inc., whose pin 2 of dimming control terminal (DIM) can be the PWM signal input terminal. PWM signal input terminals of the constant current sources 2a˜2f connect to PWM signal output terminals of the PWM generator 1, respectively. The PWM generator 1 is capable of separately outputting a plurality of PWM signals, the number of which is the same as the dimming constant current sources 3a˜3f. The timing of the PWM signals is shown in FIG. 2. All series of the PWM signals are periodic and their periods (T) and duty cycles (d) are the same as each other. That is to say, the pulse durations (τ) of the PWM signals are the same. If the number of the driven LED arrays 3a˜3f is n, the duty cycle d will be an inverse of n, i.e. d=1/n. And pulse portions of the PWM signals sequentially and repeatingly follow over time. In other words, a pulse portion of a first PWM signal is closely followed by another pulse portion of a second PWM signal. In more detail, a pulse of the second PWM signal occurs at the instant another pulse of the first PWM signal ends. The timing of the other pulses can be analogized by the same token. Suppose that the pulse duration τ=1 ms and n=6, the period T of each PWM signal is 6 ms and the duty cycle d=1/6≈16.67%.

Each PWM signal is sent to one of the dimming constant current sources 2a˜2f, so that the dimming constant current source 2a˜2f can separately output a constant current driving power having the same timing as input corresponding PWM signal to one of the LED arrays 3a˜3f. Therefore, the LED arrays can generate a high frequency blink whose timing is identical to FIG. 2. That is to say, each single LED array 3a˜3f has a separate blink frequency of 1/T Hz and the LED arrays 3a˜3f as a whole has a overall blink frequency of n/T Hz. Following the numerals in the abovementioned example, each single LED array 3a˜3f has a separate blink frequency of 166.7 Hz and the overall blink frequency is 1 kHz. If the pulse duration τ of each PWM signal is set as 0.1 ms, the overall blink frequency will rise to 10 kHz. Further, if τ is set as 0.05 ms, the overall blink frequency will be 20 kHz. If τ is set as 0.0286 ms, the overall blink frequency will be 35 kHz.

The invention makes a plurality of LED arrays 3a˜3f sequentially and repeatingly blink with high frequency, and applies a driving current larger than rated average forward current I_{AVG} and necessarily not greater than rated peak pulsed forward current I_{PK}. As a result, instantaneous luminous intensity of LEDs can be effectively heightened. Further by means of persistence of vision of the human eye, the heightened instantaneous luminous intensity can form a visual effect almost equal to continuous luminous intensity. In other words, a heightened overall brightness is achieved.

While exemplary embodiment of the foregoing invention has been set forth for purposes of illustration, the foregoing description should not be deemed a limitation of the invention herein. Accordingly, various modifications, adaptations, and alternatives may occur to one skilled in the art without departing from the spirit and the scope of the present invention.

What is claimed is:

1. A circuit for driving a plurality of light emitting diodes (LEDs), each the LED having a rated average forward current I_{AVE} and a rated peak pulsed forward current I_{PK}, the circuit comprising:
a pulse width modulation (PWM) generator capable of outputting a plurality of periodic PWM signals whose periods and duty cycles are the same, wherein each the duty cycle is an inverse of number of the PWM signals, and pulse portions of the PWM signals sequentially and repeatingly follow over time; and
a plurality of dimming constant current sources, each having a PWM signal input terminal connecting to the PWM generator for receiving the PWM signal, wherein a driving current output by the dimming constant current source is controlled by the PWM signal to cause synchronous intermittence, and is larger than the I_{AVG} but not larger than the I_{PK};
whereby the LEDs can be separately connected to one of the dimming constant current sources for being separately driven by the intermittent driving current to blink.

2. A light emitting diode (LED) driver circuit comprising:
a pulse width modulation (PWM) generator capable of outputting a plurality of periodic PWM signals whose periods and duty cycles are the same, the duty cycles being an inverse of number of the PWM signals, and pulse portions of the PWM signals sequentially and repeatingly following over time;
a plurality of dimming constant current sources, each having a PWM signal input terminal connecting to the PWM generator for receiving the PWM signal, wherein a driving current output by the dimming constant current source is controlled by the PWM signal to cause synchronous intermittence; and
a plurality of LEDs having a rated average forward current I_{AVG} and a rated peak pulsed forward current I_{PK}, and separately connecting to one of the dimming constant current sources, wherein the driving current is larger than the I_{AVG} but not larger than the I_{PK}.

3. The circuit of claim 2, wherein each of the LED is an LED array.
